(19) United States
(12) Patent Application Publication
(10) Pub. No.: US 2011/0085001 A1
(43) Pub. Date: Apr. 14, 2011

(54) Ejection Examination Apparatus and Printing Apparatus

(75) Inventor: Sukehiro Ito, Nagano-ken (JP)

(73) Assignee: SEIKO EPSON CORPORATION, Tokyo (JP)

(21) Appl. No.: 12/902,895

(22) Filed: Oct. 12, 2010

(30) Foreign Application Priority Data
Oct. 14, 2009 (JP) 2009-237535

(51) Int. Cl. B41J 29/38

(52) U.S. Cl. 347/14

(57) ABSTRACT

A small-sized module configured of a detection electrode and a determination unit is provided.

An ejection examination apparatus is disclosed, including: a head that ejects a liquid from a nozzle; a detection electrode that faces the nozzle with a predetermined interval between the detection electrode and the nozzle; a power source that sets the detection electrode to a predetermined potential; a determination unit that detects a potential change in the detection electrode arising due to ejection of the liquid from the nozzle and determines a nozzle in the head that does not eject liquid based on the potential change in the detection electrode; and a cap portion that makes contact with the head when printing is not being performed and that houses the detection electrode and the determination unit, the determination unit being sealed by an insulator.

### CROSS-REFERENCE TO RELATED APPLICATION

Japanese Patent Application No. 2009-237535 is hereby incorporated by reference in its entirety.

### BACKGROUND

1. Technical Field

The present invention relates to ejection examination apparatuses and printing apparatuses.

2. Related Art

In printers that form images by ejecting ink, there are cases where ink is not ejected from a nozzle and the desired image cannot be obtained as a result. In order to detect such a problem, a sensor for determining whether or not ink has been properly ejected from a nozzle has been developed. JP-A-2003-53949 discloses a sensor in which a printed circuit board and an ink droplet detection element are configured as a single unit.

As a method for determining whether or not ink has been ejected from a nozzle, there exists a method in which a potential difference is imparted upon the nozzle and a detection electrode and a change in the potential of the detection electrode caused by the ejection of a liquid from the nozzle is detected.

However, such a detection method has been problematic in that it is necessary to employ a high potential difference between the nozzle and the detection electrode. A necessity to employ a high potential difference in this manner leads in turn to problems such as an increase in the size of a determination unit included in the detection circuit. Such an increase in size then leads to an increase in the size of the printer that contains those elements. It is thus desirable to reduce the size of the detection electrode and the determination unit.

### SUMMARY

An advantage of some aspects of the invention is to provide an ejection examination apparatus that includes a small-sized detection electrode and determination unit.

An ejection examination apparatus according to an aspect of the invention includes a head that ejects a liquid from a nozzle; a detection electrode that faces the nozzle with a predetermined interval between the detection electrode and the nozzle; a power source that sets the detection electrode to a predetermined potential; a determination unit that detects a potential change in the detection electrode arising due to ejection of the liquid from the nozzle and determines a nozzle in the head that does not eject liquid based on the potential change in the detection electrode; and a cap portion that makes contact with the head when printing is not being performed and that houses the detection electrode and the determination unit, the determination unit being sealed by an insulator.

Other features of the invention will be made clear by the descriptions in this specification and the appended drawings.

### BRIEF DESCRIPTION OF THE DRAWINGS

The invention will be described with reference to the accompanying drawings, wherein like numbers reference like elements.

FIG. 1A is a block diagram illustrating a printing system that includes a printer and a computer, and FIG. 1B is a perspective view of a printer.

FIG. 2A is a cross-sectional view of a head, and FIG. 2B is a diagram illustrating an arrangement of nozzles provided in a nozzle plate.

FIGS. 3A to 3C are diagrams illustrating a positional relationship between a head and a cap mechanism during a recovery operation.

FIG. 4 is a diagram illustrating a cap as viewed from above.

FIG. 5A is a diagram illustrating a missing dot detection unit, and FIG. 5B is a block diagram illustrating a detection control unit.

FIG. 6A is a diagram illustrating an example of a driving signal used during ejection examination, FIG. 6B is a diagram illustrating a voltage signal outputted from an amplifier in the case where ink has been ejected from a nozzle due to a driving signal, and FIG. 6C is a diagram illustrating a voltage signal that is an ejection examination result for multiple nozzles.

FIG. 7 is a cross-sectional side view illustrating a cap according to an embodiment.

### DESCRIPTION OF EXEMPLARY EMBODIMENTS

The descriptions in this specification and the appended drawings will make clear at least the following points.

An ejection examination apparatus according to an aspect of the invention includes a head that ejects a liquid from a nozzle; a detection electrode that faces the nozzle with a predetermined interval provided between the detection electrode and the nozzle; a power source that sets the detection electrode to a predetermined potential; a determination unit that detects a potential change in the detection electrode arising due to ejection of the liquid from the nozzle and determines a nozzle in the head that does not eject liquid based on the potential change in the detection electrode; and a cap portion that makes contact with the head when printing is not being performed and that houses the detection electrode and the determination unit, the determination unit being sealed by an insulator.

In this manner, the determination unit is sealed by the insulator, and thus the determination unit can be housed within the cap portion even under circumstances in which liquid is ejected within the cap portion during examination. It is thus possible to provide an ejection examination apparatus that includes a small-sized detection electrode and determination unit. Furthermore, because the distance between the detection electrode and the determination unit that are housed within the cap portion can be reduced, noise arising between the two elements can also be reduced, thus making it possible to carry out a more accurate nozzle examination.

In the ejection examination apparatus, it is desirable for the determination unit in the cap portion to be sealed so that the liquid does not reach the interior of the determination unit. Doing so eliminates short-circuits within the determination unit caused by the liquid, thus making it possible to house the determination unit within the cap portion with ease.

Furthermore, it is desirable for the detection electrode to include an electrode and a liquid absorbing member. Although the head prevents the nozzles from becoming clogged by ejecting liquid when printing is not carried out, employing the stated configuration results in the liquid being absorbed by the liquid absorbing member. The liquid is conductive, and thus the detection electrode can be configured of the electrode and the liquid absorbing member as a single unit.

Furthermore, it is desirable for the determination unit to be a circuit board in which a circuit and a base board are formed as a single unit, and for the circuit board to be housed within the cap portion so that the base board side is on the side that faces the head. Doing so makes it possible to provide the electrode on the side of the circuit board, thus making it possible to configure an ejection examination module configured of the electrode and the circuit board in a more compact manner.

Furthermore, it is desirable for the liquid absorbing member, the electrode, the base board, and the circuit to be housed within the cap portion in that order from the side that faces the head. Doing so makes it possible to configure an ejection examination module configured of the electrode and the circuit board in a more compact manner.

Furthermore, it is desirable for the determination of a nozzle that does not eject to be carried out based on a signal indicating a change in electrostatic capacitance. Doing so makes it possible to determine a nozzle that does not eject liquid based on an electrostatic capacitance that changes when liquid is ejected from the head.

Furthermore, it is desirable for the head to include a nozzle plate having multiple nozzles, and for the nozzle plate to be connected to a ground. Doing so makes it possible to determine a nozzle that does not eject liquid based on an electrostatic capacitance that changes when liquid is ejected from a nozzle in the nozzle plate.

A printing apparatus according to another aspect of the invention includes a head that ejects a liquid from a nozzle; a detection electrode that faces the nozzle with a predetermined interval between the detection electrode and the nozzle; a power source that sets the detection electrode to a predetermined potential; a determination unit that detects a potential change in the detection electrode arising due to ejection of the liquid from the nozzle and determines a nozzle in the head that does not eject liquid based on the potential change in the detection electrode; and a cap portion that makes contact with the head when printing is not being performed and that houses the detection electrode and the determination unit, the determination unit being sealed by an insulator.

This makes it possible to provide a printing apparatus in which is installed an ejection examination apparatus that includes a small-sized detection electrode and determination unit.

### Ink Jet Printer

An embodiment of the invention will be described using an ink jet printer (a “printer 1” hereinafter) as an example of a printing apparatus.

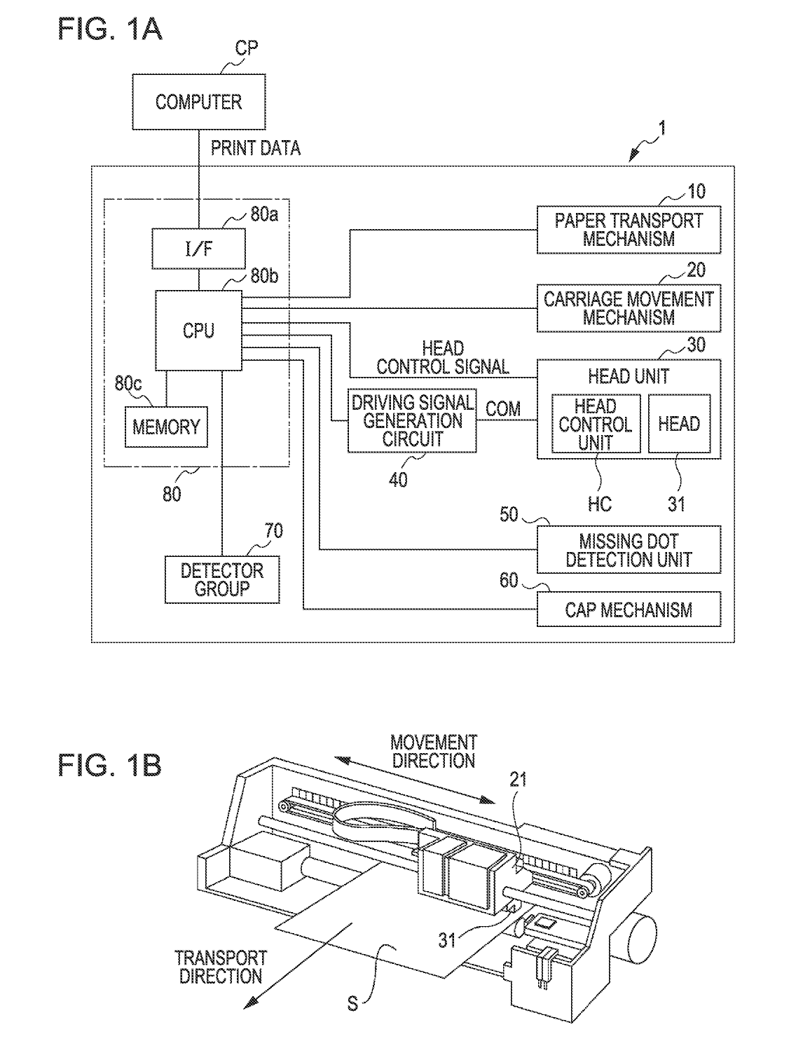

FIG. 1A is a block diagram illustrating a printing system that includes the printer 1 and a computer CP, and FIG. 1B is a perspective view of the printer 1. The printer 1 ejects ink, which is a type of liquid, onto a medium such as paper, cloth, film, or the like. The computer CP is communicably connected to the printer 1. The computer CP outputs print data based on an image to be printed to the printer 1 in order to cause the printer 1 to print the image. The printer 1 includes a paper transport mechanism 10, a carriage movement mechanism 20, a head unit 30, a driving signal generation circuit 40, a missing dot detection unit 50, a cap mechanism 60, a detector group 70, and a controller 80.

The paper transport mechanism 10 transports paper in a transport direction. The carriage movement mechanism 20 moves a carriage 21 to which the head unit 30 is attached in a movement direction (the direction perpendicular to the transport direction).

The head unit 30 includes a head 31 and a head control unit HC. The head 31 causes ink to be ejected toward the paper. The head control unit HC controls the head 31 based on head control signals from the controller 80 of the printer 1.

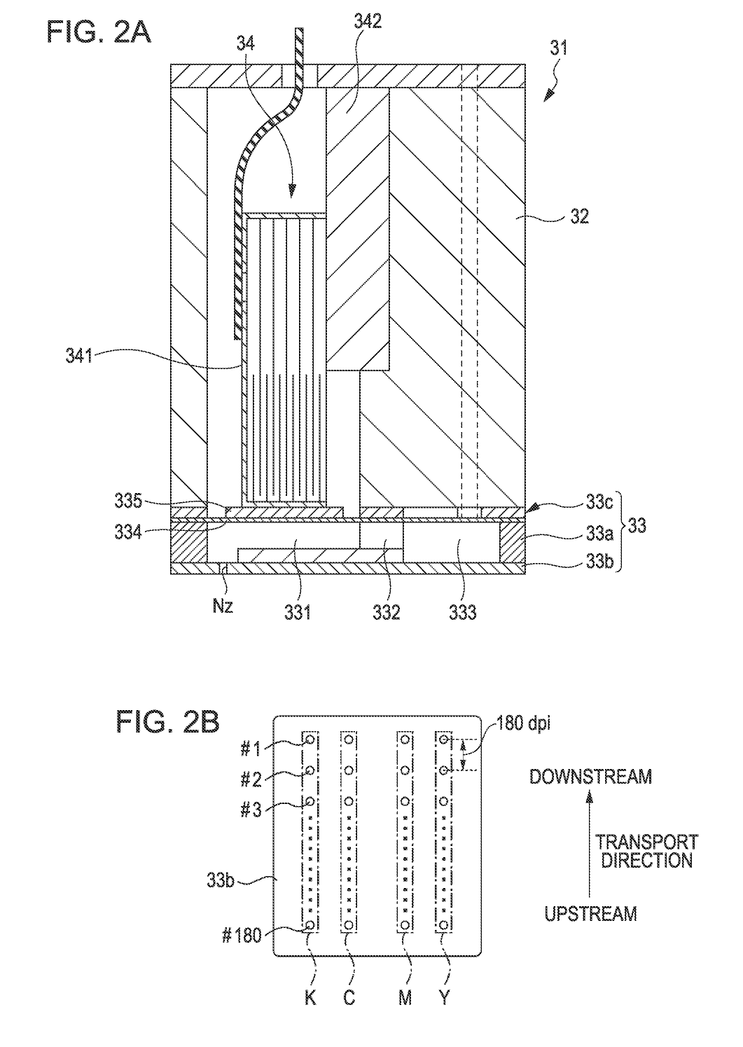

FIG. 2A is a cross-sectional view of the head 31. The head 31 includes a case 32, a flow channel unit 33, and a piezoelectric element unit 34. The case 32 is a member for housing and anchoring piezoelectric elements PZT, and is created using a nonconductive resin material such as epoxy resin or the like.

The flow channel unit 33 includes a flow channel formation plate 33a, a nozzle plate 33b, and a vibrating plate 33c. The nozzle plate 33b is bonded to one of the surfaces of the flow channel formation plate 33a, whereas the vibrating plate 33c is bonded to the other surface of the flow channel formation plate 33a. Cavities and grooves that serve as pressure chambers 331, ink supply channels 332, and common ink chambers 333 are formed in the flow channel formation plate 33a. The flow channel formation plate 33a is created using, for example, a silicon substrate. A nozzle group composed of multiple nozzles Nz is provided in the nozzle plate 33b. The nozzle plate 33b is created using a conductive plate-shaped member, such as a thin metal plate. The nozzle plate 33b is connected to a ground line and is thus at a ground potential. Diaphragm portions 334 are provided in locations of the vibrating plate 33c corresponding to respective pressure chambers 331. The diaphragm portions 334 are deformed by the piezoelectric elements PZT, thus causing the volume of the corresponding pressure chambers 331 to change. Note that the piezoelectric elements PZT and the nozzle plate 33b are electrically insulated from each other due to the presence of the vibrating plate 33c, an adhesive layer, and so on therebetween.

The piezoelectric element unit 34 includes a piezoelectric element group 341 and an anchor plate 342. The piezoelectric element group 341 has a comb-tooth shape. Each single comb tooth corresponds to a piezoelectric element PZT. The tip surface of each piezoelectric element PZT is bonded to an island portion 335 in the corresponding diaphragm portion 334. The anchor plate 342 supports the piezoelectric element group 341 and serves as a portion for attachment to the case 32. The piezoelectric element PZT is a type of electromechanical conversion element, extending in the lengthwise direction when a driving signal COM is applied thereto, and thus instigating a change in the pressure of liquid within the pressure chamber 331. A change in pressure in ink within the pressure chamber 331 arises due to a change in the volume of the pressure chamber 331. Ink droplets can be caused to be ejected from the nozzles Nz by utilizing this change in pressure.

FIG. 2B is a diagram illustrating an arrangement of the nozzles (Nz) provided in the nozzle plate 33b. Multiple nozzle rows, in each of which 180 nozzles (#1 through #180) are arranged along the transport direction of the paper at a pitch equivalent to 180 dpi, are provided in the nozzle plate. Each nozzle row ejects a different color ink, and four nozzle rows are provided in the nozzle plate 33b. Specifically, these are a black ink nozzle row K, a cyan ink nozzle row C, a magenta ink nozzle row M, and a yellow ink nozzle row Y.

The driving signal generation circuit 40 generates the driving signal COM. When the driving signal COM is applied to the piezoelectric element PZT, the piezoelectric element extends and shrinks, and the volume of the pressure chamber 331 corresponding to that nozzle Nz changes. As a result, the driving signal COM is applied to the head 31 during printing, during missing dot examination (discussed later), during flushing, which is a recovery operation for nozzles Nz that generate missing dots, and so on.

The missing dot detection unit 50 detects whether or not ink is being ejected from the nozzles Nz. The cap mechanism 60 suppresses the evaporation of ink carrier from the nozzles Nz, performs suction operations for sucking ink from the nozzles Nz in order to restore the ejection capabilities of the nozzles Nz, and so on. The detector group 70 is configured of multiple detectors that monitor the status of the printer 1. Detection results from the detectors are outputted to the controller 80.

The controller 80 performs overall control of the printer 1, and includes an interface unit 80a, a CPU 80b, and a memory 80c. The interface unit 80a exchanges data with the computer CP. The memory 80c secures regions for holding computer programs, work regions, and so on. The CPU 80b controls the various elements to be controlled (the paper transport mechanism 10, the carriage movement mechanism 20, the head unit 30, the driving signal generation circuit 40, the missing dot detection unit 50, the cap mechanism 60, and the detector group 70) in accordance with a computer program stored in the memory 80c.

In the printer 1 configured thus, a dot formation process, in which dots are formed upon the paper by continuously ejecting ink from the head 31 that moves along the movement direction of the carriage, and a transport process, in which the paper is transported in the transport direction, are repeated. As a result, dots are formed in different locations than the locations in which dots were formed by the previous dot formation process, thus printing a two-dimensional image upon the medium.

### Ejection Examination and Recovery Operation

There are cases where a nozzle becomes clogged when ink (liquid) is not ejected from the nozzle for a long period of time, foreign objects such as paper particles stick to the nozzle, and so on. When a nozzle is clogged, a phenomenon in which ink is not ejected from the nozzle at the time when the ink is supposed to be ejected and a dot is not formed where the dot is supposed to be formed (a missing dot) occurs. The occurrence of missing dots leads to a drop in image quality. Accordingly, in this embodiment, in the case where a missing dot nozzle has been detected by the missing dot detection unit 50 executing ejection examination, ink is once again caused to be ejected properly from the missing dot nozzle through the execution of a recovery operation.

Note that it is favorable to carry out the missing dot examination immediately after the printer 1 has been turned on, when the printer 1 has received the print data from the computer CP and will commence printing, or the like. It is also favorable to carry out the missing dot examination every predetermined amount of time during an extended printing session. Hereinafter, the ejection examination will be described after descriptions are first given regarding a recovery operation for a missing dot nozzle.

### Recovery Operation

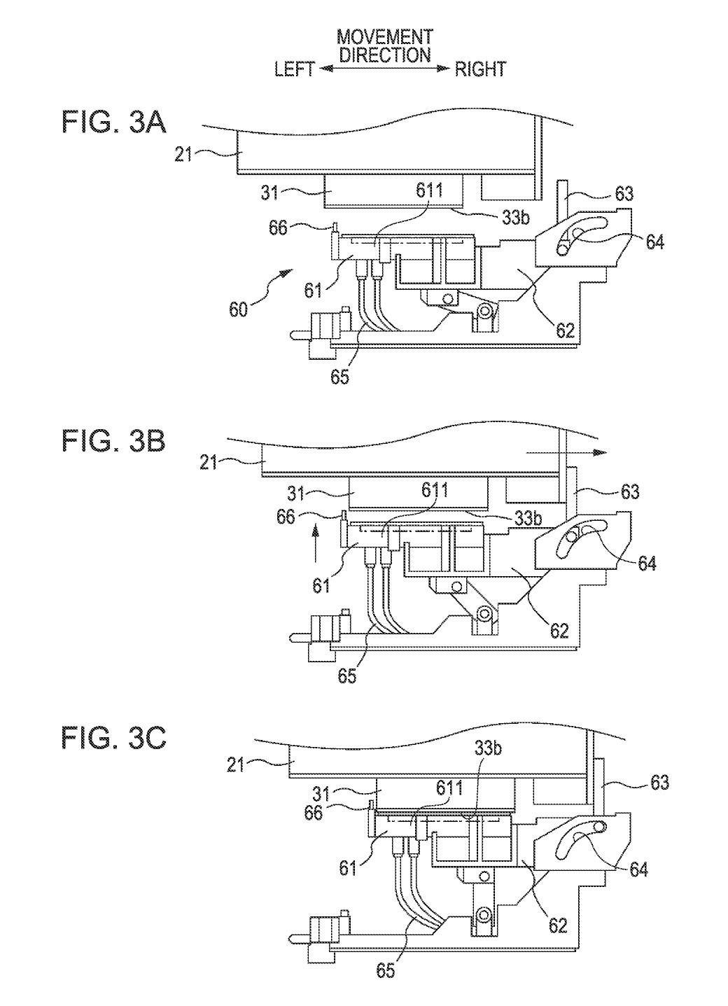

FIGS. 3A to 3C are diagrams illustrating a positional relationship between the head 31 and the cap mechanism 60 during the recovery operation. First, the cap mechanism 60 will be described. The cap mechanism 60 includes a cap 61 and a slider member 62 that supports the cap 61 and is capable of moving diagonally up and down. The cap 61 has a rectangular base portion (not shown) and a side wall portion 611 that protrudes upward from the edges of the base portion, and has a thin box shape whose upper side that faces the nozzle plate 33b is open. A sheet-shaped moisture retention member 612, created from a porous material such as felt, a sponge, or the like, is disposed within the space that is surrounded by the base portion and the side wall portion 611. Note that the configuration of the interior of the cap 61 will be described later.

As shown in FIG. 3A, when the carriage 21 has left a home position (here, the right side in the movement direction), the cap 61 is positioned at a location that is sufficiently lower than the surface of the nozzle plate 33b (also called the “nozzle surface” hereinafter). Then, as shown in FIG. 3B, when the carriage 21 returns toward the home position, the carriage 21 makes contact with a contact portion 63 provided in the slider member 62, and the contact portion 63 moves toward the home position along with the carriage 21. When the contact portion 63 moves toward the home position, the slider member 62 rises along a long hole 64 provided for guidance, and the cap 61 also rises as a result. Finally, as shown in FIG. 3C, when the carriage 21 is located in the home position, the upper portion of the cap 61 comes into tight contact with the nozzle plate 33b. Accordingly, the evaporation of ink carrier from the nozzles can be suppressed by positioning the carriage 21 at the home position when the power is off, when printing is suspended for a long period of time, and so on.

Next, the recovery operation will be described. A “flushing operation” exists as a recovery operation for missing dot nozzles. The flushing operation is an operation for eliminating clogs in nozzles by forcefully ejecting ink droplets continuously from each of the nozzles when there is a small space between the nozzle surface and the opening edge of the cap 61, as shown in FIG. 3B.

A waste liquid tube 65 is connected in the space between the bottom surface of the cap 61 and the side wall portion 611, and a suction pump (not shown) is connected midway in the waste liquid tube 65. As another recovery operation, “pump suction” is carried out in a state in which the opening edge of the cap 61 is in contact with the nozzle surface, as shown in FIG. 3C. When the suction pump is operated in a state in which the side wall portion 611 of the cap 61 is in tight contact with the nozzle surface, the space within the cap 61 is depressurized. Accordingly, the ink within the head 31 can be sucked out along with ink, paper particles, and so on, making it possible to restore missing dot nozzles.

In addition, moving the carriage 21 in the movement direction while maintaining the position of the cap mechanism 60 illustrated in FIG. 3B makes it possible to remove ink droplets, foreign objects, and so on that have adhered to the nozzle surface, through the use of a wiper 66 that protrudes upward further than the side wall portion 611 of the cap 61. Accordingly, ink can once again be ejected properly from nozzles that had been clogged with foreign objects.

### Missing Dot Detection Unit 50

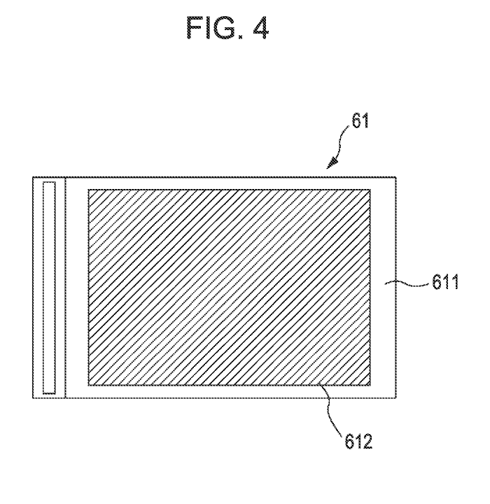

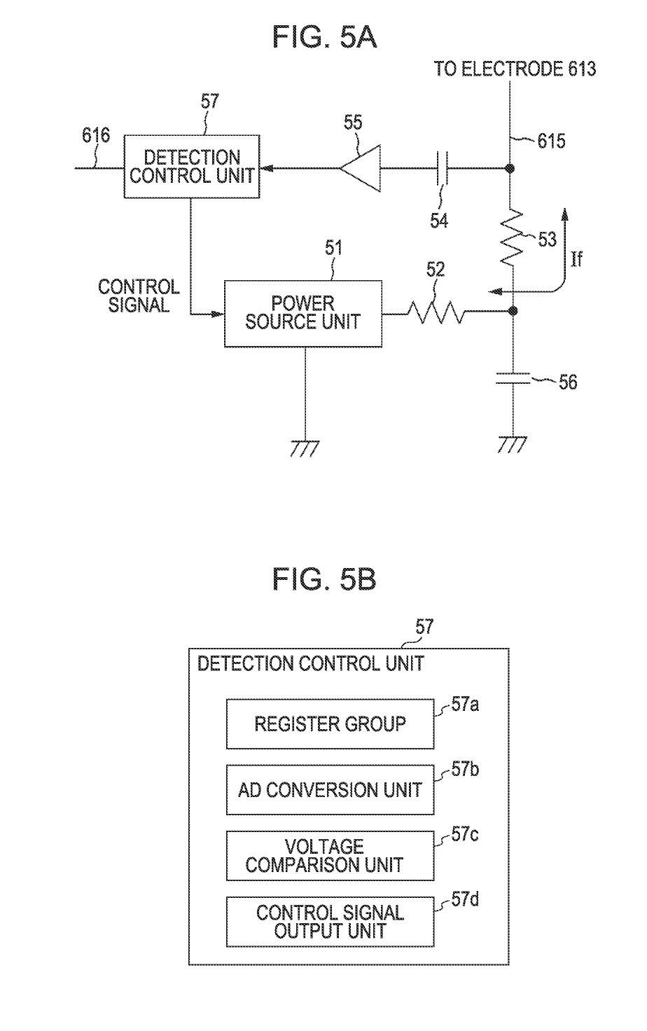

FIG. 4 is a diagram illustrating the cap 61 as viewed from above, FIG. 5A is a diagram illustrating the missing dot detection unit 50, and FIG. 5B is a block diagram illustrating a detection control unit 57. The missing dot detection unit 50 detects missing dot nozzles by attempting to actually eject ink from the nozzles and determining whether or not ink has been properly ejected. First, the configuration of the missing dot detection unit 50 will be described. As shown in FIG. 5A, the missing dot detection unit 50 includes a power source unit 51, a first limiting resistance 52, a second limiting resistance 53, a detection capacitor 54, an amplifier 55, a smoothing capacitor 56, and the detection control unit 57.

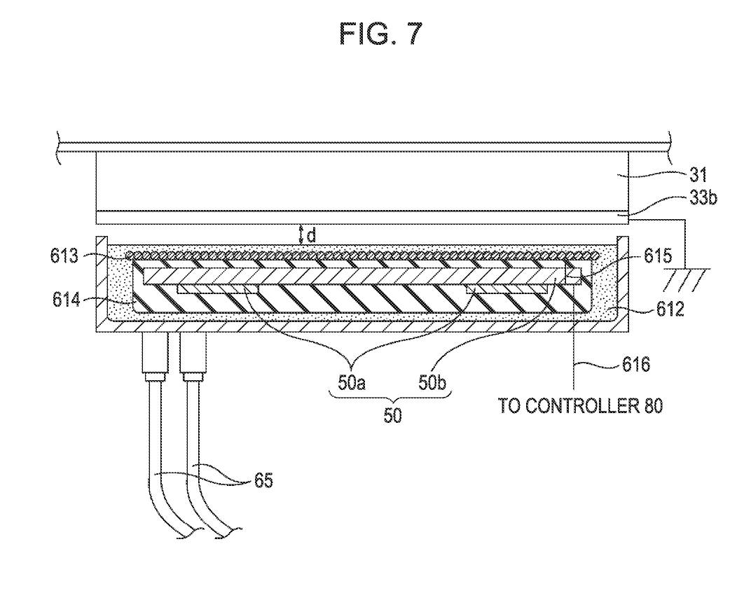

Although the internal structure of the cap 61 will be described later, when missing dot detection is carried out, the nozzle surface opposes the surface of the moisture retention member 612 in the cap 61 with a predetermined interval d provided therebetween, as shown in FIGS. 3B and 7. A wire-shaped electrode 613 is provided within the cap 61. This electrode 613 is set at a potential of approximately 42 V during the missing dot detection operation. The electrode 613 is wired back and forth within the cap 61 so as to form a flat plane shape, a structure that enables a wide area to be uniformly charged. Furthermore, the ink carrier in this embodiment is a conductive liquid (such as water), and thus when the electrode 613 is set to a high potential while the moisture retention member 612 is in a moist state, the surface of the moisture retention member 612 takes on that same potential. As a result, the region in which ink is ejected from the nozzles is also uniformly charged across a wide area.

The power source unit 51 is a type of power source that sets the electrode 613 within the cap 61 to a predetermined potential. The power source unit 51 according to this embodiment is configured of an approximately 42 V DC power source, and the operation thereof is controlled through a control signal from the detection control unit 57.

The first limiting resistance 52 and the second limiting resistance 53 are disposed between the output terminal of the power source unit 51 and the electrode 613, and limit the current flowing between the power source unit 51 and the electrode 613. In this embodiment, the first limiting resistance 52 and the second limiting resistance 53 have the same resistance value, and the first limiting resistance 52 and the second limiting resistance 53 are connected serially. As illustrated in FIG. 5A, one end of the first limiting resistance 52 is connected to the output terminal of the power source unit 51, whereas the other end of the first limiting resistance 52 is connected to one end of the second limiting resistance 53; the other end of the second limiting resistance 53 is connected to the electrode 613.

The detection capacitor 54 is an element for extracting a potential change component of the electrode 613; one conductor thereof is connected to the electrode 613, whereas the other conductor thereof is connected to the amplifier 55. By disposing the detection capacitor 54 between those two elements, a bias component (DC component) of the electrode 613 can be removed, thus making it easier to handle the signal.

The amplifier 55 amplifies and outputs the signal (potential change) present in the other end of the detection capacitor 54. Through this, the change component of the potential can be handled as a voltage signal having a change range of approximately 2 to 3 V. The combination of the detection capacitor 54 and the amplifier 55 corresponds to a type of detection unit, and detects an electrical change occurring in the electrode 613 due to the ejection of an ink droplet.

The smoothing capacitor 56 suppresses a sudden change in the potential. One end of the smoothing capacitor 56 according to this embodiment is connected to a signal line that connects the first limiting resistance 52 and the second limiting resistance 53, whereas the other end of the smoothing capacitor 56 is connected to a ground.

The detection control unit 57 is an element that controls the missing dot detection unit 50. As shown in FIG. 5B, the detection control unit 57 includes a register group 57a, an AD conversion unit 57b, a voltage comparison unit 57c, and a control signal output unit 57d. The register group 57a is configured of multiple registers. Determination results for the respective nozzles Nz, a determination voltage threshold, and so on are stored in the respective registers. The AD conversion unit 57b converts the post-amplification voltage signal (an analog value) outputted from the amplifier 55 into a digital value. The voltage comparison unit 57c compares the size of an amplitude value based on the post-amplification voltage signal with a voltage threshold. The control signal output unit 57d outputs a control signal for controlling the operation of the power source unit 51.

### Ejection Examination

With the printer 1, the nozzle plate 33b is connected to a ground and is thus set to a ground potential, whereas the electrode 613 provided within the cap 61 is set to a potential of approximately 42 V. Because the nozzle plate is at the ground potential, the ink droplets ejected from the nozzles are also at the ground potential. The nozzle plate 33b and the electrode 613 face each other with the predetermined interval d therebetween (see FIG. 7), and an ink droplet is caused to be ejected from a nozzle subject to detection. The detection control unit 57 then obtains, via the detection capacitor 54 and the amplifier 55, the electrical change occurring in the electrode 613 due to the ejection of the ink droplet, obtaining this change as a voltage signal SG. Then, the detection control unit 57 determines whether or not the ink droplet ejected from the nozzle subject to detection has been properly ejected based on the amplitude value (potential change) in the voltage signal SG.

The principle behind this detection is based on the fact that, due to the nozzle plate 33b and the electrode 613 being disposed with the predetermined interval d provided therebetween, these elements behave like capacitors. Ink extending in column form from the nozzle Nz (an ink column) takes on the ground potential due to contact with the nozzle plate 33b, which is connected to a ground, as shown in FIG. 5A. This ink extension changes the electrostatic capacitance of the capacitor. In other words, a capacitor is formed by the ink at the ground potential and the electrode 613 due to ink being ejected from the nozzle, and the electrostatic capacitance thereof changes.

When the electrostatic capacitance decreases, the size of the load that can be stored between the nozzle plate 33b and the electrode 613 drops. Accordingly, an excessive electrical charge is transferred from the electrode 613 to the power source unit 51 via the limiting resistances 52 and 53. In other words, a current flows toward the power source unit 51. On the other hand, if the electrostatic capacitance increases or a reduced electrostatic capacitance returns to its original value, the electrical charge moves from the power source unit 51 to the electrode 613 via the limiting resistances 52 and 53. In other words, a current flows toward the electrode 613. When such a current (also called an “ejection examination current If”, for simplicity's sake) flows, the potential of the electrode 613 changes. The change in the potential of the electrode 613 also appears as a potential change in the other conductor of the detection capacitor 54 (that is, the conductor on the side of the amplifier 55). Accordingly, whether or not an ink droplet has been ejected can be determined by monitoring a potential change in the other conductor.

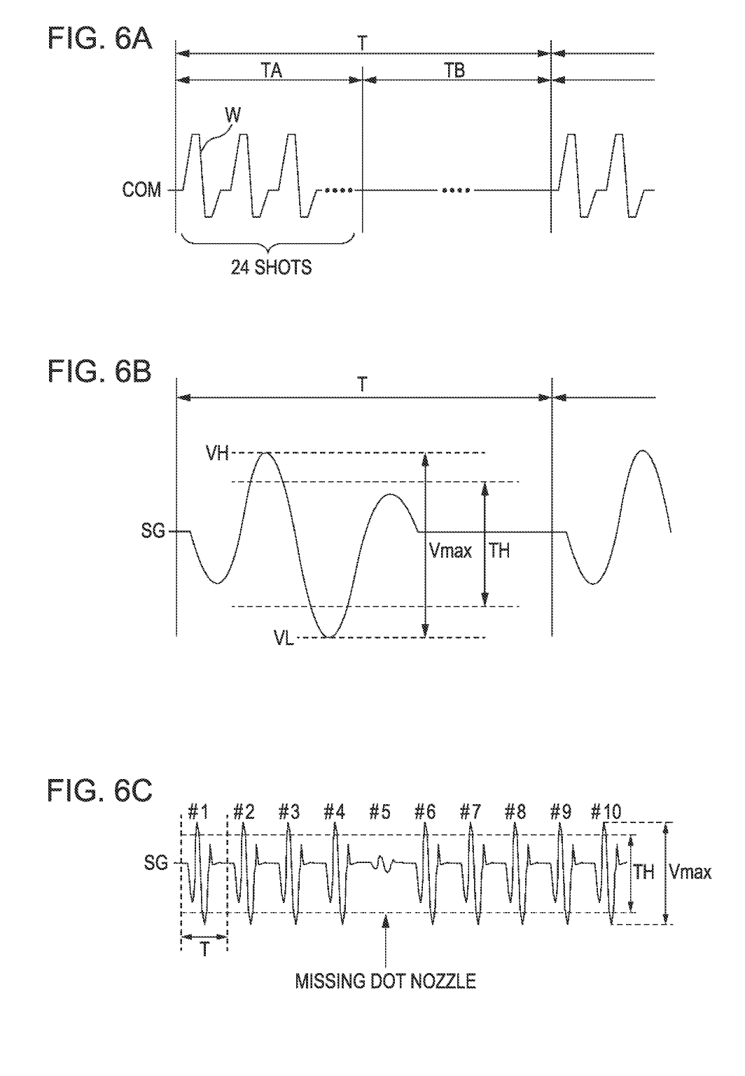

FIG. 6A is a diagram illustrating an example of the driving signal COM used during ejection examination, FIG. 6B is a diagram illustrating the voltage signal SG outputted from the amplifier 55 in the case where ink has been ejected from a nozzle due to the driving signal COM, and FIG. 6C is a diagram illustrating the voltage signal SG that is an ejection examination result for multiple nozzles (#1 through #10). The driving signal COM has multiple (for example, 24) driving waveforms W for ejecting ink from a nozzle within a former period TA in a repeat interval T, whereas an intermediate potential is held constant during a latter period TB. The driving signal generation circuit 40 repeatedly generates the multiple driving waveforms W (24 driving waveforms) each repeat interval T. The repeat interval T corresponds to the time required to perform examination on a single nozzle.

First, the driving signal COM is applied to the piezoelectric element corresponding to a nozzle that is subject to examination for the entire repeat interval T. As a result, ink droplets are continuously ejected from the nozzle subject to ejection examination during the former period TA (for example, 24 shots are made). Accordingly, the potential of the electrode 613 changes, and the amplifier 55 outputs that potential change to the detection control unit 57 as the voltage signal SG indicated in FIG. 6B (a sine curve). It should be noted that because the amplitude of the voltage signal SG caused by the ink droplet corresponding to a single shot is small, a voltage signal SG of an amplitude sufficient for examination purposes is obtained by continuously ejecting ink droplets from the nozzle.

The detection control unit 57 calculates a maximum amplitude Vmax from the voltage signal SG in the detection interval (T) for the nozzle subject to examination (that is, the difference between a highest voltage VH and a lowest voltage VL) and compares the maximum amplitude Vmax with a predetermined threshold TH. If ink is ejected from the nozzle subject to examination due to the driving signal COM, the potential of the electrode 613 will change, and the maximum amplitude Vmax of the voltage signal SG will exceed the threshold TH. However, if ink is not ejected from the nozzle subject to examination due to clogging or the like, or only a small amount of ink has been ejected, the potential of the electrode 613 will not change or will change only by a small amount, and thus the maximum amplitude Vmax of the voltage signal SG will not exceed the threshold TH.

After the driving signal COM has been applied to the piezoelectric element corresponding to a given nozzle, the driving signal COM is then applied to the piezoelectric element corresponding to the next nozzle subject to examination throughout the repeat interval T; in this manner, the driving signal COM is applied to the piezoelectric element corresponding to each nozzle subject to examination throughout the repeat interval T on a nozzle-by-nozzle basis. Accordingly, the detection control unit 57 can obtain, for each repeat interval T, the voltage signal SG in which a potential change is manifested as a sine curve, as shown in FIG. 6C.

For example, in the results illustrated in FIG. 6C, the maximum amplitude Vmax of the voltage signal SG corresponding to the examination interval for nozzle #5 is less than the threshold TH, and thus the detection control unit 57 determines that nozzle #5 is a missing dot nozzle. However, the maximum amplitudes Vmax of the voltage signals SG corresponding to the examination intervals of the other nozzles (#1 through #4 and #6 through #10) exceed the threshold TH, and thus the detection control unit 57 determines that the other nozzles are functioning normally. In the case where a missing dot nozzle has been detected by the missing dot detection unit 50 in such a manner, the controller 80 of the printer 1 executes a recovery operation on the head 31. It is thus possible to print high-quality images with no missing dots.

### Configuration of Cap 61 in This Embodiment

FIG. 7 is a cross-sectional side view illustrating the cap 61 according to this embodiment. The internal structure of the cap 61 will be described hereinafter with reference to FIG. 7.

The cap 61 includes, in its interior, the electrode 613, the moisture retention member 612 (which corresponds to a liquid absorbing member), an insulating member 614, and the missing dot detection unit 50 (which corresponds to a determination unit).

The missing dot detection unit 50 includes circuits 50a and a base board 50b. The circuits 50a and the base board 50b are sealed by the insulating member 614. The insulating member 614 is a member such as rubber or the like. The reason the circuits 50a and the base board 50b are sealed by the insulating member 614 in this manner is to prevent short-circuits caused by ink ejected onto the moisture retention member 612. The electrode 613 and the circuits 50a connected by a connection wire 615 that passes through the base board 50b and the insulating member 614. The circuits 50a and the controller 80, meanwhile, are connected by a connection wire 616 that passes through the insulating member 614, the moisture retention member 612, and the side wall portion 611. The electrode 613 is provided on the back side of the base board 50b. Doing so makes it possible to manufacture the module that is made up of the electrode 613 and the missing dot detection unit 50 in a more compact form.

The moisture retention member 612 is provided within the cap 61 so as to encapsulate the insulating member 614. As mentioned earlier, ink is ejected onto the moisture retention member 612 during recovery operations. Because the ink is conductive, the moisture retention member 612 becomes conductive through the ink, and the configuration is such that the moisture retention member 612 and the electrode 613 together function as an electrode. In other words, the moisture retention member 612 can function as part of an electrode through the ink.

With such a configuration, the moisture retention member 612, the electrode 613, the base board 50b, and the circuits 50a are housed within the cap 61, in that order starting from the side on which the head 31 is disposed.

In the past, the missing dot detection unit 50 was not installed within the cap 61, and was instead provided outside of the cap 61. In such a case, the missing dot detection unit 50 and the electrode 613 were connected by a member such as a harness, and there were cases where signals could not be properly obtained due to the influence of the harness. It was thus necessary to set the voltage applied to the electrode 613 to 600 V to 1 kV in order to properly obtain the voltage signal SG, which led to problems such as an increase in the size of the power source unit and, in turn, an increase in the size of the printer 1 itself.

As opposed to this, if the cap 61 is configured as described in this embodiment, the electrode 613 and the missing dot detection unit 50 are housed within the cap 61, and thus the distance between the two can be reduced. Accordingly, a connection member such as a harness is unnecessary, and it is thus possible to properly detect missing dots even if a lower voltage is applied to the electrode 613.

### Other Embodiments

Although the aforementioned embodiment describes the printer 1 as an example of a printing apparatus, the invention is not limited thereto; the invention can also be realized in a liquid ejection apparatus that expels or ejects a fluid aside from ink (liquids, liquid materials in which the particles of a functional material have been dispersed, fluid materials such as gels, and so on). The same techniques as those described in the aforementioned embodiment may be applied to various types of apparatuses that employ ink jet techniques, such as color filter manufacturing apparatuses, dyeing apparatuses, microfabrication apparatuses, semiconductor manufacturing apparatuses, surfacing apparatuses, three-dimensional molding machines, liquid vaporizing apparatuses, organic EL manufacturing apparatuses (and in particular, high-polymer EL manufacturing apparatuses), display manufacturing apparatuses, deposition apparatuses, DNA chip manufacturing apparatuses, and so on. The methods used thereby and manufacturing methods thereof also fall within the scope of application of the invention.

The aforementioned embodiment has been provided to facilitate understanding of the invention and is not to be interpreted as limiting the invention in any way. It goes without saying that many variations and modifications can be made without departing from the essential spirit of the invention, and thus all such variations and modifications also fall within the scope of the invention.

What is claimed is:

1. An ejection examination apparatus comprising:
a head that ejects a liquid from a nozzle;
a detection electrode that faces the nozzle with a predetermined interval between the detection electrode and the nozzle;
a power source that sets the detection electrode to a predetermined potential;
a determination unit that detects a potential change in the detection electrode arising due to ejection of the liquid from the nozzle and determines a nozzle in the head that does not eject liquid based on the potential change in the detection electrode; and
a cap portion that makes contact with the head when printing is not being performed and that houses the detection electrode and the determination unit, the determination unit being sealed by an insulator.

2. The ejection examination apparatus according to claim 1, wherein in the cap portion, the determination unit is sealed so that the liquid does not reach the interior of the determination unit.

3. The ejection examination apparatus according to claim 1, wherein the detection electrode includes an electrode and a liquid absorbing member.

4. The ejection examination apparatus according to claim 3,
wherein the determination unit is a circuit board in which a circuit and a base board are formed as a single unit; and
the circuit board is housed within the cap portion so that the base board side is on the side that faces the head.

5. The ejection examination apparatus according to claim 4, wherein the liquid absorbing member, the electrode, the base board, and the circuit are housed within the cap portion in that order from the side that faces the head.

6. The ejection examination apparatus according to claim 1, wherein the determination of a nozzle that does not eject liquid is carried out based on a signal indicating a change in electrostatic capacitance.

7. The ejection examination apparatus according to claim 1, wherein the head includes a nozzle plate having multiple nozzles, and the nozzle plate is connected to a ground.

8. A printing apparatus comprising:
a head that ejects a liquid from a nozzle;
a detection electrode that faces the nozzle with a predetermined interval between the detection electrode and the nozzle;
a power source that sets the detection electrode to a predetermined potential;
a determination unit that detects a potential change in the detection electrode arising due to ejection of the liquid from the nozzle and determines a nozzle in the head that does not eject liquid based on the potential change in the detection electrode; and
a cap portion that makes contact with the head when printing is not being performed and that houses the detection electrode and the determination unit, the determination unit being sealed by an insulator.
